(19) United States
(12) Patent Application Publication
(10) Pub. No.: US 2022/0176454 A1
(43) Pub. Date: Jun. 9, 2022

(54) ADDITIVE MANUFACTURING POWDER RECIRCULATION SYSTEM

(71) Applicant: RENISHAW PLC, Wotton-Under-Edge, Gloucestershire (GB)

(72) Inventors: David Edward BEEBY, Wotton-under-Edge (GB); David John WHITTON, Alveston (GB)

(73) Assignee: RENISHAW PLC, Wotton-Under-Edge, Gloucestershire (GB)

(21) Appl. No.: 17/600,615

(22) PCT Filed: Apr. 29, 2020
(86) PCT No.: PCT/GB2020/051044

§ 371 Date: Oct. 1, 2021

(30) Foreign Application Priority Data
May 2, 2019 (GB) 1906182.9

(51) Int. Cl. B22F 10/73; B22F 12/52; B33Y 30/00; B33Y 40/00

(52) U.S. Cl. CPC B22F 10/73; B33Y 40/00; B33Y 30/00; B22F 12/52

(57) ABSTRACT

An additive manufacturing powder recirculation apparatus including: a powder recirculation loop having: an inlet for receiving powder from an additive manufacture apparatus; an outlet for supplying powder to the additive manufacture apparatus; and a powder flow path extending between the inlet and outlet. A diverter valve in the powder flow path is configured to selectively place the powder flow in fluid communication with either the downstream powder recirculation loop or a hopper outside of the powder recirculation loop.

### FIELD OF INVENTION

The present invention relates to powder based additive manufacturing and powder handling apparatus for powder based additive manufacture.

### BACKGROUND

Additive manufacturing methods (which in some cases may be referred to as “3D printing”) typically form three-dimensional articles by building up material in a layer-by-layer manner. Additive manufacture has several benefits over traditional manufacturing techniques, for example: additive manufacture has very few limitations on component geometry; additive manufacturing may reduce material waste (as even complex geometries can be produced at or near to their final net-shape); and additive manufacture does not require dedicated tooling so can enable flexible manufacture of small batches or individually tailored products.

One type of additive manufacture is powder bed fusion, which is particularly applicable to high strength materials such as metal alloys (but may also be used for ceramic or polymer based materials). In powder bed fusion a thin layer of powder is provided on a base and is selectively exposed to an energy source to fuse sections of the layer. A further layer of powder is provided over the solidified layer, generally by lowering a platform supporting the powder, and the subsequent layer is selectively fused. This fuses the powder both within the new layer and to the fused regions of the previous layer. The process is repeated to build the full component on a layer-by-layer basis. Powder bed fusion includes, for example, Selective Laser Melting (in which the energy source is a Laser) and Electron Beam Melting (in which the energy source is an Electron Beam).

In order to gain the full benefits of the additive manufacture process, the powder used in additive manufacture must be extremely fine and of high quality (both chemically and physically). Characteristics of the powder such as the particle size, particle shape and particle shape distribution can, for example, directly impact powder flow and layer build up such that they may have a direct impact upon the final component quality and consistency. Metallic powder particles for use in powder bed additive manufacture may, for example, have a particle size in the range of 15 to 45 μm (for Selective Laser Melting).

For both process and safety reasons the powders used in additive manufacture must be handled with caution. For example, fine metal powders are a health risk to humans through skin contact or inhalation and are a fire or explosion risk. Further, exposure of metal powders to moisture and/or oxygen can cause powder degradation. For example, some materials such as titanium alloys are particularly reactive and prone to absorption of atmospheric impurities such as oxygen and nitrogen. It is, therefore, best practice to keep powders for additive manufacture in an inert atmosphere for example by using sealed powder flasks and powder loading arrangements.

The amount of unfused powder in a typical layer-by-layer build may be relatively high such that much of the powder in the powder bed is available for re-use. In order to maintain process quality and consistency, any recycled unfused powder will typically require some degree of processing before being re-introduced to the additive manufacture process to ensure that the recycled powder is chemically and/or physically consistent with virgin powder to provide consistent results. For example, the recycled powder may pass through a sieve or filter to remove oversized particles (which can be formed by the heating of the additive process—for example particles that have become sintered together or have formed irregular shaped agglomerates).

Despite the advantages of powder recirculation arrangements, they are not universally adopted. In some applications of additive manufacture stringent performance or regulatory requirements may, for example, currently limit the use of recirculation. Such restrictions may require the use of virgin powder or may require unfused powder to be tested and certified prior to reuse. Thus, there is a desire to provide additive manufacturing method and apparatus which enable the increased use of recirculation powders.

### SUMMARY OF INVENTION

According to a first aspect of the invention, there is provided an additive manufacturing powder recirculation apparatus comprising:
a powder recirculation loop having:
   an inlet for receiving powder from an additive manufacture apparatus;
   an outlet for supplying powder to the additive manufacture apparatus; and
   a powder flow path extending between the inlet and outlet;
a diverter valve in the powder flow path, the diverter valve being configured to selectively place the powder flow in fluid communication with either the downstream powder recirculation loop or a hopper outside of the powder recirculation loop.

By placing the outlet in fluid communication with either the downstream powder recirculation loop or a hopper outside of the loop, embodiments of the invention enable the powder flow from the powder recirculation loop to be either maintained within the powder recirculation loop for recycling through the additive manufacturing process or to be accumulated outside of the loop for later removal. It will be appreciated that the “hopper” outside of the powder recirculation loop is not limited to any specific arrangement and may be any suitable container or conduit for directing or receiving powder, for example it could be a removable container. Typically, the downstream powder recirculation loop will include a powder supply hopper for the additive manufacturing process. Thus, the diverter valve may direct the powder to one of either: a first hopper outside of the powder recirculation loop; or a second hopper within the powder recirculation loop.

The diverter valve body may comprise spaced apart inner and outer sidewalls. Thus, the body may define an outlet void between wall portions. For example, where the body is cylindrical the outlet void may comprise an annular space formed between concentric cylindrical walls. The outlet void may be at least partially separated into a plurality of outlet ports, for example a series of segments (such as circumferential segments separated by baffles or longitudinal wall sections). Each outlet void may have an inlet aperture in communication with the interior of the valve body and an outlet aperture in communication with an exterior of the valve body. The inlet apertures may be formed in the inner wall of the housing and the outlet apertures may be formed in an exterior surface of the housing, for example in the base of the valve body.

The diverter valve may further comprise a rotary valve element. The rotary valve element may be disposed within the body and rotatable by an actuator to selectively place one of the outlet ports in fluid communication with the interior of the valve body. The inner wall of the housing and the valve element have complimentary cylindrical cross sections. The valve element may comprise a substantially cylindrical member. The valve element may be a truncated cylinder. The truncated cylinder may have upper and lower surfaces which are non-parallel. The base surface may be perpendicular with the axis of the valve and the upper surface may be at an oblique angle to the axis. The valve element may be a cylindrical wedge (i.e. the oblique angled surface may intersect the plane of the base of the cylinder). During operation of the valve the circumferential position of the lowest portion of the cylinder may align with the opening of the valve and the higher portions may close an opening. Thus, the truncated cylinder may provide a sloped surface to direct powder flow towards the open outlet.

The diverter valve may comprise a body. For example, the body may be a cylindrical housing. The diverter valve may include a valve element moveably positioned within a valve body. The valve element may be moveable by an actuator. The valve element may be moveable between a first position in which the outlet of the diverter is in fluid communication with the downstream powder recirculation loop and a second position in which the outlet is in fluid communication with the hopper outside of the powder recirculation loop.

The apparatus may further comprise a separator within the powder flow path. The separator may include a plurality of separator stages. For example, the separator may include a first stage for separating undersize particles and a second stage for separating oversize particles. The diverter valve may be between stages of the separator.

The separator may comprise an oversize particle separator. The oversize particle separator may be a sieve or filter, for example an ultrasonic sieve. The oversize particle separator may be downstream of the diverter valve. The oversize particle separator may have an inlet. The inlet of the oversize particle separator may be in fluid communication with an outlet of the diverter valve (it will be appreciated that this diverter valve outlet would be the outlet which is in fluid communication with the downstream powder recirculation loop).

The separator may comprise a powder separator to separate powder from a gas recirculation loop. The gas recirculation loop may deliver the gas from the powder separator back to a location where powder received by the inlet is entrained into the gas flow. The powder separator may also be an undersize particle separator. The powder separator may be upstream of the diverter valve. The powder separator may have an outlet. The powder separator outlet may be in fluid communication with the inlet of the diverter valve.

The powder separator may be a dynamic separator, for example various types of inertial separator will be known to those skilled in the art. In particular, the powder separator may be a cyclonic separator.

The provision of the diverter valve between the powder separator and the oversize particle separator may be beneficial as the oversize particle separator is only used for processing powder which will remain in use within the additive manufacturing system. Powder directed out of the powder recirculation loop will typically be processed outside of the system before being re-used.

The diverter valve body may be coaxial with the outlet of the separator, for example the powder separator. In particular, the valve body may be coaxial with the operational axis of the cyclonic separator. The valve body may form a passageway which is contiguous with the outlet of the separator.

A further aspect of the invention may provide an additive manufacturing system comprising an additive manufacturing powder recirculation apparatus in accordance with embodiments and an additive manufacturing apparatus. The additive manufacturing apparatus may be a powder bed additive manufacturing apparatus.

The powder handling apparatus may comprise a module which is adapted for removable attachment to an additive manufacturing system. Such a modular system is advantages in enabling the powder system to be removed from the machine and substituted for a new module when a powder change is required (such that only the process chamber parts of the additive manufacture system require cleaning).

Whilst the invention has been described above, it extends to any inventive combination of the features set out above or in the following description or drawings.

### DESCRIPTION OF THE DRAWINGS

Embodiments of the invention may be performed in various ways, and embodiments thereof will now be described by way of example only, reference being made to the accompanying drawings, in which:

FIG. 1 shows an existing commercially available additive manufacturing system;

FIGS. 2a and 2b are schematic representations of an additive manufacture powder handling apparatus;

FIGS. 3a and 3b are is three-dimensional views of a diverter valve arrangement in accordance with embodiments of the invention;

FIGS. 4a and 4b are cross-sectional views of the diverter valve of FIGS. 3a and 3b;

FIG. 5 is a three-dimensional, ghost view of a diverter valve according to a second embodiment of the invention;

FIG. 6 is the diverter valve shown in FIG. 5 in a first position; and

FIG. 7 is the diverter valve as shown in FIG. 5 in a second position.

### DETAIL DESCRIPTION OF EMBODIMENTS

It may be appreciated that references herein to vertical or horizontal are with reference to the axis of the additive manufacture process. In particular, as powder bed fusion is a layer by layer process the horizontal axis corresponds to the plane of the layers (which is in turn defined by the powder bed and support) and the vertical axis is perpendicular to the powder bed.

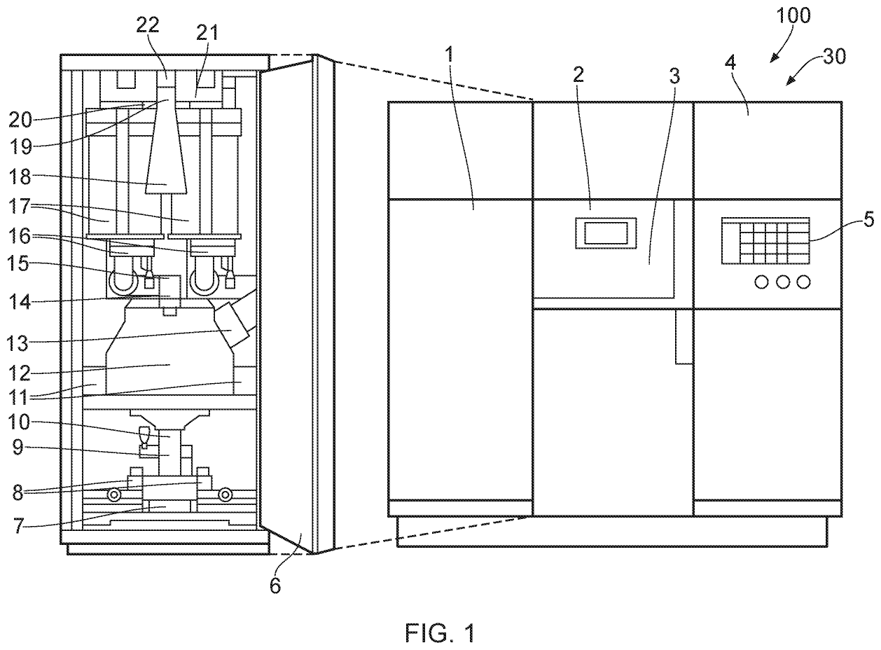

A commercially available additive manufacturing system 100, the Applicant's RenAM 500 Series, is shown in FIG. 1. The additive manufacturing system 100 includes both an additive manufacture apparatus 30 and an integrated powder handling apparatus 1. The additive manufacturing apparatus includes a process chamber 2, accessible via a chamber door 3, in which a laser is used to melt selective regions of a bed of powder on a layer-by-layer process. The additive manufacture process is generally controlled by a computer and may have a touchscreen interface 4 for operator interaction. The powder handling apparatus 1 is provided in an integrated cabinet 6 and accessible through a service door. The powder handling apparatus includes a hopper 12 for storing powder for use by the additive manufacturing apparatus 30. The hopper 12 may be filled with powder via a filling point 15 which is provided with an isolation valve 14. The powder handling apparatus includes an inlet in the form of a return pipe 13 for returning unused powder from the process chamber 2 to the hopper 12. Below the hopper 12 there is provided a powder metering screw 10 which feeds, via isolation valves 8 and 9, an ultrasonic sieve 7. The ultrasonic sieve is used to remove oversized particles from the powder so that they can be collected and removed from the machine via a metal flask, such as flask 18. Different size sieve meshes may be use for different materials. The powder handling apparatus maintains the powder loaded into the hopper and passing through the recycling system under an inert atmosphere. The powder handling apparatus may also include filtering for the inert gas used in the process chamber and/or powder handling apparatus (although the skilled person will also appreciate that such filtering may alternatively be provided in the additive manufacturing apparatus 30). The example system of FIG. 1 includes both first and second filters 17 capture process emissions from the inert gas atmosphere.

Another configuration for an additive manufacturing system has been proposed in US Patent Application US2019/0001413. The system described in this patent application has a powder supply apparatus and a powder recovery apparatus which are combined to form a subassembly that is designed as an interchangeable module.

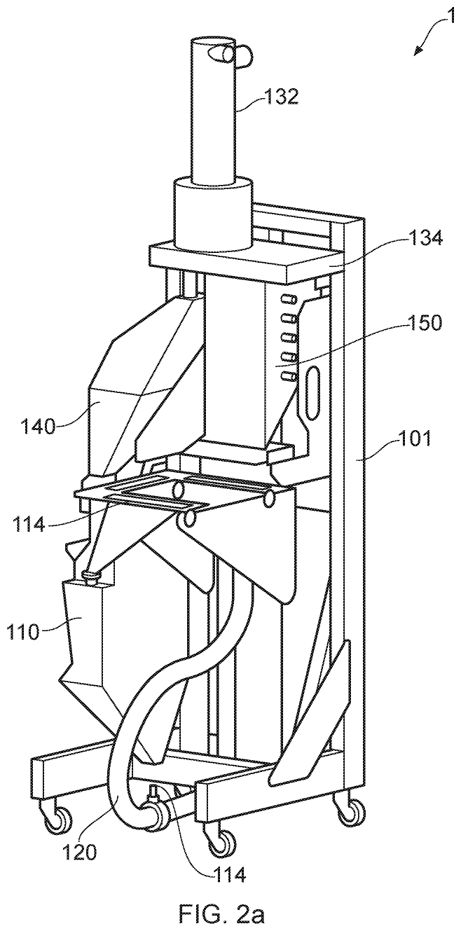

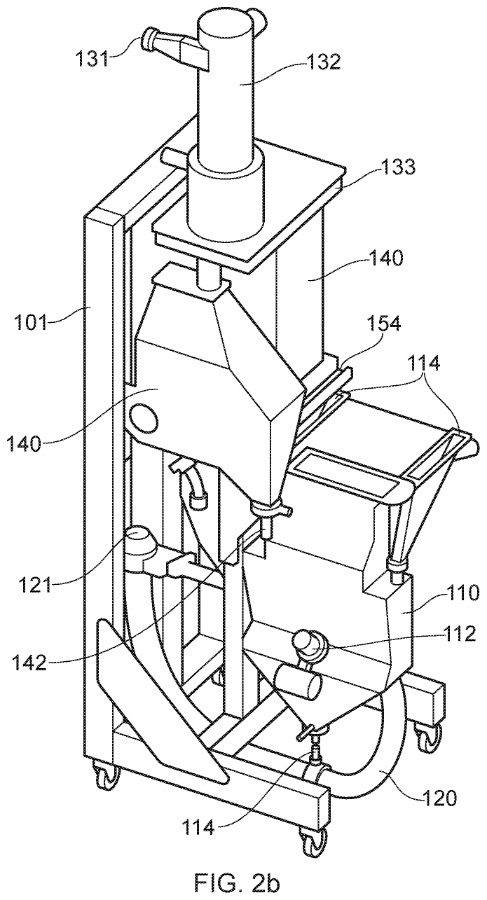

An additive manufacturing powder handling apparatus 1 in accordance with an embodiment of the invention is shown in FIGS. 2a and 2b (which are alternate views of the same apparatus). The embodiment shown in FIG. 2 is adapted to be a self-contained powder handling module and it may be noted that it is mounted on a frame 101 with casters to enable ease of removal to and from the associated additive manufacturing apparatus. It will be appreciated that powder handling apparatus 100 in accordance with embodiments of the invention may be utilised in systems having either an integrated or an interchangeable powder handling apparatus and are not limited accordingly.

It may be noted that, for clarity purposes, some parts of the powder handling apparatus 100 are omitted in FIG. 2. Such features, for example ducting sections would be considered standard by those skilled in the art. Additionally, the skilled person would understand that the invention is not limited to any specific additive manufacturing apparatus, or particularly any specific build chamber thereof, for example the additive manufacturing apparatus may be substantially similar to the RenAM 500 Series described above (and shown in FIG. 1) with only routine modification required to operate with the powder handling apparatus of FIG. 2.

The powder handling apparatus 100, comprises a powder silo 110 which may receive powder from either a fresh powder inlet 112 and/or from the process chamber (not shown) of the additive manufacturing system via powder inlets 114. The silo 110 has a powder feed 114 at its lowermost end and tapers towards the powder feed to direct powder contained therein. The powder silo is located on the supporting frame 101 at a level below the position of the process chamber (which would be in the space immediately above the inlets 114) such that it may be gravity fed when receiving powder. The powder feed 114 is arranged to pass powder through a valve into a gas recirculation loop 120.

The gas recirculation loop 120 circulates inert gas around the powder system. The gas recirculation loop also takes output gas, including emissions from the process, from the process chamber to a filter system before returning inert gas to the process chamber. The skilled person may appreciate that there may be multiple flow routes for gas through the chamber to optimise emissions removal and maintain a clean and optically clear process chamber. For example, the RenAM 500 series includes both a high volume and flow horizontally across the powder bed and a cascading flow of gas from a showerhead type arrangement in the ceiling of the process chamber.

The inert gas flow in the gas recirculation loop 120 provides a motive flow for carrying powder. The powder is fed into the loop 120 by the powder feed 114 and is entrained in the inert gas such that it is carried from the lower most portion of the powder handling apparatus 1 to the upper most portion. Advantageously, once at the upper part of the powder handling apparatus 1, the powder can move under gravity. At the top of the frame 101 is positioned a separator 130 comprising both a powder separator, in the form of a cyclonic separator, 132 and an oversize particle separator, in the form of an ultrasonic sieve, 134. The skilled person will appreciate that both the cyclonic separator 132 and ultrasonic sieve 135 may be of any convenient design and of a type well known in the art. Further it will be appreciated that other separator arrangements are also possible and may be used with embodiments of the invention. The powder separator of the illustrated embodiment includes an inlet port 131 through which inert gas and powder is introduced and an outlet port 133 through which gas leaves the cyclonic separator 132. It will be appreciated that the ducting to/from the ports 131 and 133 has been omitted from FIG. 2 for clarity but that in practice, for example, a simple duct would continue the recirculation loop 120 by extending from the coupling 121 to the inlet port 131.

Gas separated from the powder in the cyclone 132 may be directed from the outlet port 133 to at least one filter for further removal of emissions or contaminants before the gas is returned for use in the process chamber. A pump (not shown) is located after the cyclone 132 and the filter but before powder feed 114 to propel the gas around the gas recirculation loop 120. The powder is separated from the gas by the cyclonic separator 132 and falls under gravity through to the next stage of the separator 130. The cyclone 132 may be considered to define a minimum particle size since particles smaller than the size separated by the cyclone will be carried away by the gas flow and will not remain in the recirculation loop. For example, particles of less than 10 microns may be removed from with the gas flow exiting the outlet port 133 of the cyclone 132. It may be appreciated that if the powder transport is by a means other than pneumatic action, then the cyclone 132 could be replaced with another form of separator for only removing undersized particles (without the need to also separate gas and powder).

After leaving the cyclone 132, oversize particles subsequently separated from the powder. For example, the powder may pass through an ultrasonic sieve 134 to remove oversize particles from the powder. Thus, the sieve defines the maximum size of particle to remain in the recirculation loop.

As will be explained further below, the embodiment of FIG. 2 includes two hoppers 140 and 150 to which powder exiting the separator 130 may be selectively directed and accumulated. The first hopper 140 is a “total loss” hopper which is arranged to collect powder which is not being recycled by the powder handling apparatus. The total loss hopper is, therefore, used to accumulate unused powder so that it may be removed from the system via an outlet valve 142 provided at the bottom of the total loss hopper. As such, it will be understood that the total loss hopper 140 is not normally part of a powder recirculation loop. Whilst not being immediately recycled it is still desirable that the powder held in the total loss hopper 140 is under an inert gas. This ensures that the powder can be removed subsequently used, for example after testing or processing or for later use by the additive manufacturing system, for example for a component having less restrictive material requirements. In this regard it may be noted that the outlet 142 is positioned relatively close to, and above, an inlet 112 in an upper sidewall of the silo 110. This enables powder from the total loss hopper 140 to be reintroduced into the powder recirculation loop if required (by simply attaching a suitable hose line) without being removed from the powder handling apparatus or leaving the inert atmosphere therein.

The second hopper 150 is a powder dispensing hopper and is part of a powder recirculation loop. The powder dispensing hopper has an inlet 152 at its upper end which receives powder from the sieve 134 of the separator 130. The lower end of the powder dispensing hopper 150 tapers towards an outlet 154 for providing powder to the additive manufacturing apparatus. The outlet 154 may be an interface for connecting to the build chamber of the additive manufacturing apparatus and may include or connect to a powder dispensing arrangement. For example, the additive manufacturing system may have a drawer type powder dispensing arrangement similar to the type shown, for example, in published Patent Application WO2010/007396.

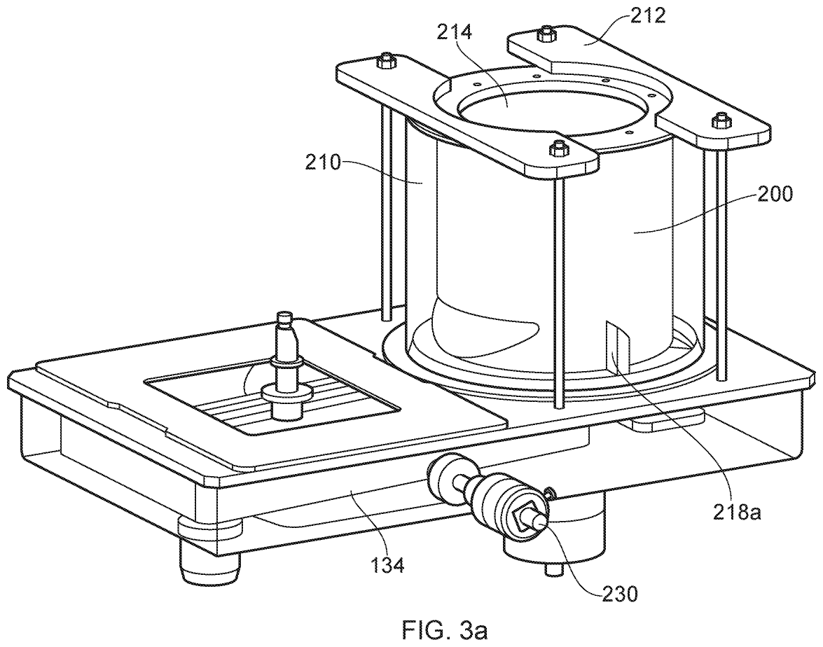

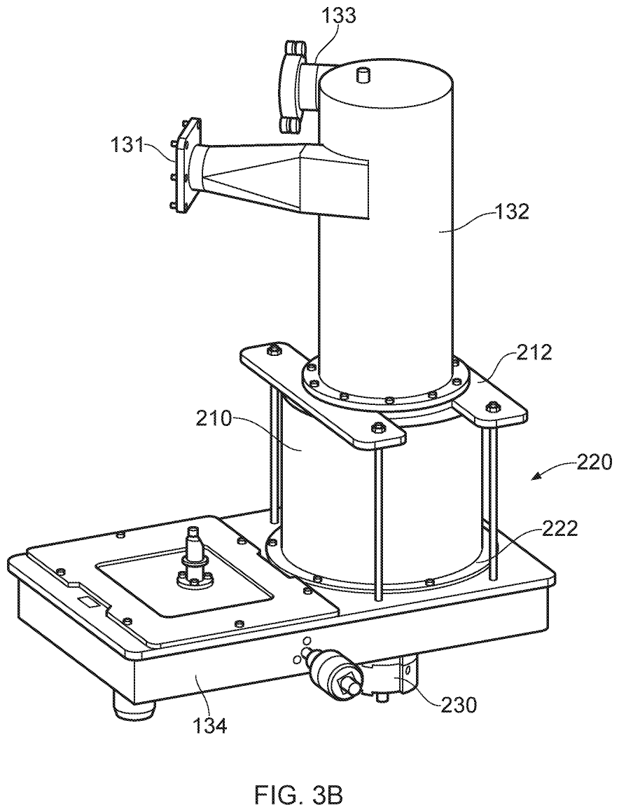

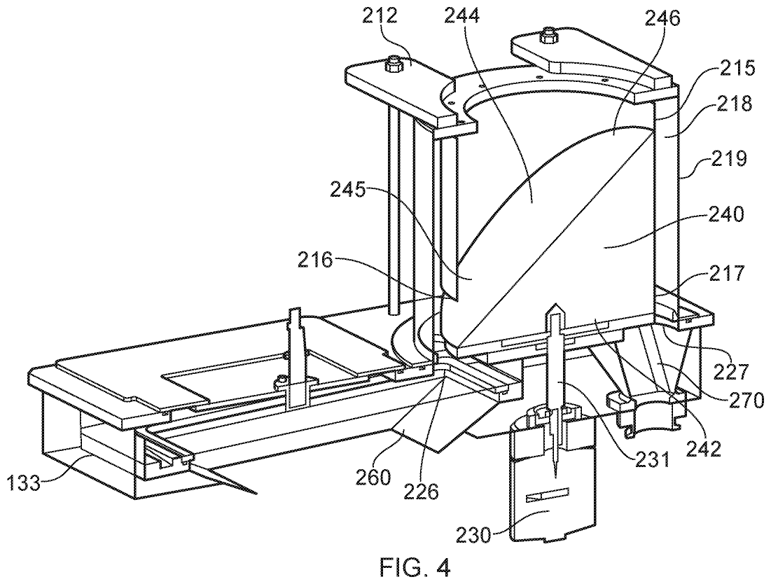

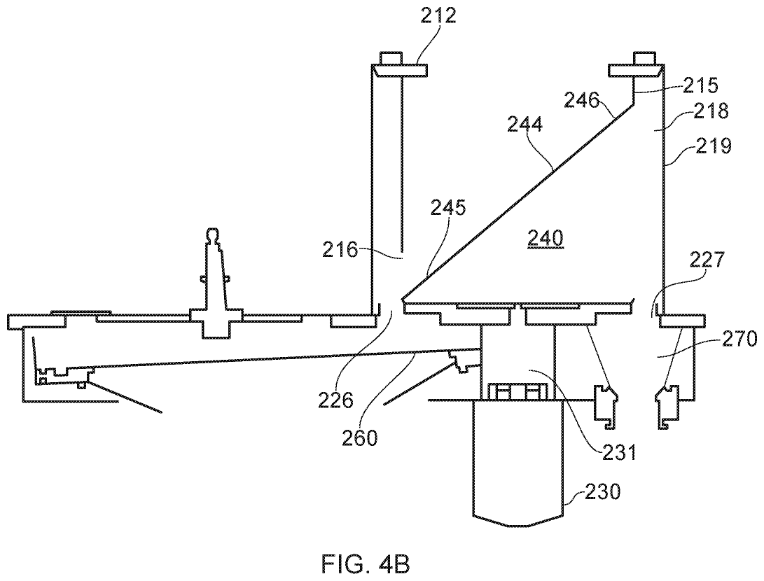

With reference to FIGS. 3 and 4, the diverter valve arrangement 200 for selectively directing powder in the powder recirculation loop to either the total loss hopper 140 or the powder dispensing hopper 150. The valve 200 is formed of a valve body 210, a valve element 240 rotatable within the body 210 and an actuator 230 for rotating the valve element 240.

The upper end 210 of the diverter valve 200 forms an inlet 214 and is attached to the outlet of the cyclone 132. The lower end of the diverter valve has a first outlet 260 which is in communication with the ultrasonic sieve 134 and a second outlet 270 which bi-passes the sieve and is in communication with the total loss hopper 140. As the total loss hopper is (in normal operation) outside of the powder recirculation loop, the outlet 270 can be considered to direct powder flowing from the cyclone 132 out of the powder recirculation loop. It will be appreciated that the ultrasonic sieve 134 is at the inlet to the powder dispensing hopper 150. As such powder directed through the outlet 260 remains in the powder recirculation loop.

The valve body 210 is formed of two concentric cylindrical walls. Both the inner wall 215 and outer wall 219 are aligned with the axis of the valve which is also aligned with the axis of the cyclone 132. The upper end 210 of the valve body is closed by a top plate 212, which includes the valve inlet aperture 214. Similarly, a bottom plate 222 closes the lower end 220 of the valve body. The bottom plate includes a pair of apertures 226 and 227 which respectively open into to the outlets 260 and 270. A central hole 223 is also provided such that the spindle 231 of an actuator 230 can pass into the interior of the valve body 210.

An annular outlet void 218 is formed between the inner wall 215 and outer wall 219. The apertures 226 and 227 of the base plate 220 are aligned with the outlet void 218 at circumferentially spaced apart (and opposed) parts of the body 210. The inner wall 215 is provided with first 216 and second 217 openings aligned with the apertures 226 and 227 at the lower end 220 of the valve body which provide inlet apertures into the outlet void 218. The outlet void 218 may be split into separate ports by including longitudinal baffles 218a between the inner wall 215 an outer wall 219. Such an arrangement will provide a physical barrier to ensure that powder exiting one of the openings 216 or 217 in the inner wall can only exit the correspondingly aligned aperture 226 or 227. Alternatively, it may be sufficient to rely upon the flow under gravity of the aligned openings to direct the powder through the aligned openings.

The valve element 240 is a cylindrical wedge shape which is seated within the inner wall 215 of the body 210 and is rotatable therein. The base 242 of the valve element 240 is circular and engages the spindle 231 of the actuator 230. The upper surface 244 of the valve element 240 extends at an oblique angle to the axis of the cylinder from a first side 245 proximal to the base 242 to an opposing side 246 where the valve element has its full height. As can be seen in FIG. 4, when the first side 244 is aligned with an opening 216 of the inner wall 215 that opening is in communication with the interior of the valve 220. The opposing side 246 of the valve element 240 blocks the other opening 217. Thus, rotation of the valve element by 180 degrees will open and close the respective apertures and place the interior of the valve into fluid communication with the corresponding outlet via the outlet void 218. The upper surface 244 will also provide a ramped surface for directing powder flow towards the open outlet.

In use, the powder recirculation system may be used in either a continuous recirculation mode or a “total loss” mode. In the continuous recirculation mode the valve element 240 is positioned such that the lower side 245 is aligned with the opening 216 and powder leaving the outlet of the cyclone 132 is directed via the ramp profile of the element 240 to exit the body 210 of the diverter valve through the opening 216, via the outlet void 218 and the aperture 226. From the outlet 226 the powder passes to the ultrasonic sieve 133 to separate and/or remove any oversize powder particles. The sieve 133 is directly above the powder dispensing hopper 150 which accumulates powder leaving the sieve ready for reintroduction into the process chamber of the additive manufacturing apparatus.

In order to switch the apparatus to a “total loss” mode the valve element needs only be rotated (for example through 180 degrees). The total loss mode could, for example, be used if an article being manufactured in the additive manufacturing apparatus has particularly strict material requirements or if a change of material is upcoming. The actuator 230 is activated to rotate the valve element 240 until the lower side 245 is aligned with the opening 217. The opposing side 246 of the valve element blocks the opening 216 when in this second position. Powder leaving the outlet of the cyclone 132 is directed via the ramp profile of the element 240 to exit the body 210 of the diverter valve through the opening 217, via the outlet void 218 and the aperture 227. The aperture 227 is in fluid communication with the total loss hopper 140 and, as such, powder leaving the cyclone 132 in this configuration is removed from the powder recirculation loop.

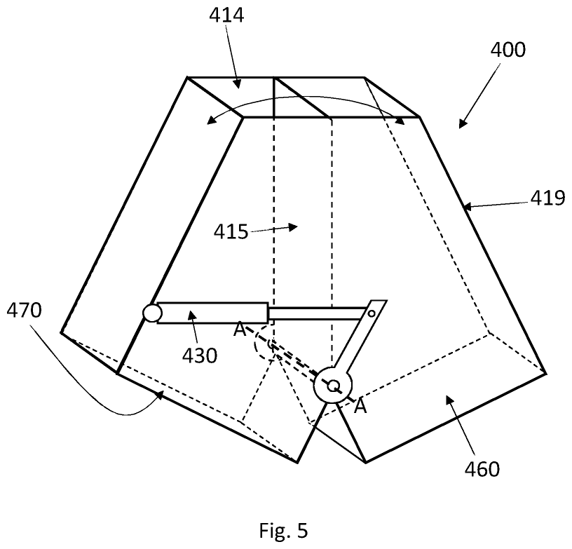

In another embodiment of the invention the diverter value 200 is replaced with the diverter valve 400 as shown in FIGS. 5 to 7. The diverter valve 400 comprises a valve body 419. An upper end of the valve body 419 forms an inlet 414 and is attached to the outlet of the cyclone 132. A lower end of valve body 419 has a first outlet 460 which is in communication with the ultrasonic sieve 134 and a second outlet 470 which bi-passes the sieve and is in communication with the total loss hopper 140. As the total loss hopper is (in normal operation) outside of the powder recirculation loop, the outlet 470 can be considered to direct powder flowing from the cyclone 132 out of the powder recirculation loop. It will be appreciated that the ultrasonic sieve 134 is at the inlet to the powder dispensing hopper 150. As such powder directed through the outlet 460 remains in the powder recirculation loop.

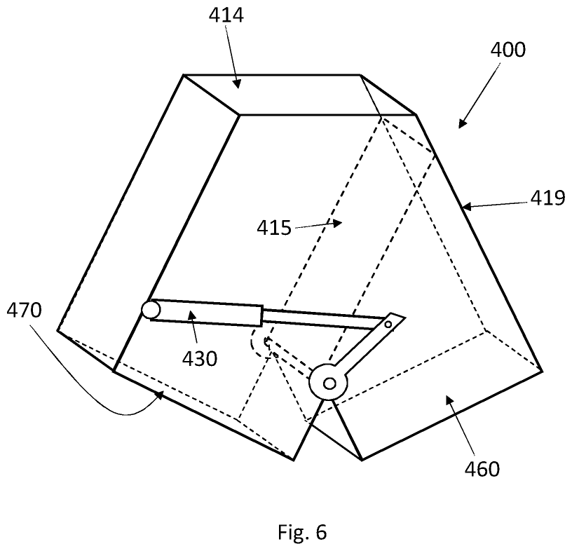

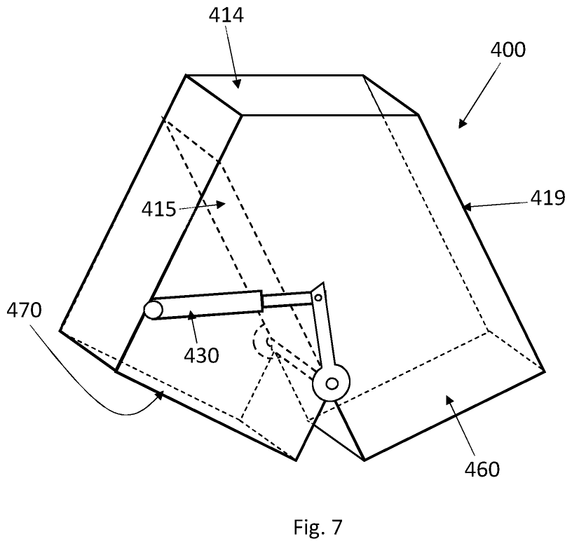

Within the valve body 419 is a closure or valve element in the form of a divider plate 415, which is mounted for rotation about an axis A such that the divider plate 415 can be rotated from a first position shown in FIG. 6, closing the second outlet 470 to powder flow but allowing powder to flow from the inlet 414 to the first outlet 460, to a second position shown in FIG. 7, closing the first outlet 460 to powder flow but allowing powder to flow from the inlet 414 to the second outlet 470. Rotation of the divider plate 415 is driven by an actuator, in this embodiment in the form of a pneumatic or hydraulic piston 430. Accordingly, in order to switch the apparatus between a powder recirculation mode and a “total loss” mode the valve element 415 is rotated. A diverter valve 400 according to this second embodiment may have advantages over the first embodiment of the diverter valve 200, in that it reduces the risk of powder becoming trapped in the valve mechanism, which may cause the valve to seize and it may be possible to manufacture a diverter valve 400 that is not as tall as diverter vale 200 whist still providing an equivalent function.

Although the invention has been described above with reference to preferred embodiments, it will be appreciated that various changes or modification may be made without departing from the scope of the invention as defined in the appended claims. For example, it will be appreciated that whilst the system described above includes two hoppers and a diverter valve with two corresponding outlets additional hoppers could be accommodated by adding additional valve outlets and valve element positions.

Further, whilst the embodiment above is described primarily for using the diverted hopper as a “total loss hopper” the skilled person will appreciate that it may have other uses. For example, the diverter valve could be used to temporarily divert powder from the powder recirculation loop for the purpose of powder testing or sampling. For the majority of the time during a build the powder from the diverter valve may be fed to the sieve for onward use in the process but at certain times during the build the diverter valve may switch the powder to the total loss hopper to sample the powder, before switching back. A user can then remove the sample of powder from the total loss hopper. The sampling could be down periodically or in response to a user input.

1. An additive manufacturing powder recirculation apparatus, the powder recirculation apparatus comprising:
a powder recirculation loop having:
an inlet for receiving powder from an additive manufacture apparatus;
an outlet for supplying powder to the additive manufacture apparatus; and
a powder flow path extending between the inlet and outlet;
a diverter valve in the powder flow path, the diverter valve being configured to selectively place the powder flow in fluid communication with either the downstream powder recirculation loop or a hopper outside of the powder recirculation loop.

2. An additive manufacturing powder recirculation apparatus as claimed in claim 1, wherein the diverter valve comprises a valve element moveably positioned within the valve body and moveable by an actuator between a first position in which the outlet of the diverter valve is in fluid communication with the downstream powder recirculation loop and a second position in which the outlet is in fluid communication with a hopper outside of the powder recirculation loop.

3. An additive manufacturing powder recirculation apparatus as claimed in claim 2, wherein the diverter valve body comprises spaced apart inner and outer sidewalls with an outlet void defined therebetween.

4. An additive manufacturing powder recirculation apparatus as claimed in claim 3, wherein the outlet void is separated into a plurality of outlet ports each having an inlet aperture in communication with the interior of the valve body and an outlet aperture in communication with an exterior of the valve body.

5. An additive manufacturing powder recirculation apparatus as claimed in claim 2, wherein the diverter valve further comprises a rotary valve element disposed within the body and rotatable by an actuator to selectively place one of the outlet ports in fluid communication with the interior of the valve body.

6. An additive manufacturing powder recirculation apparatus as claimed in claim 5, wherein the inner wall of the housing and the valve element have complimentary cylindrical cross sections and the valve element is a truncated cylinder.

7. An additive manufacturing powder recirculation apparatus as claimed in claim 1 further comprising a separator disposed within the powder flow path.

8. An additive manufacturing powder recirculation apparatus as claimed in claim 7, wherein the separator comprises an oversize particle separator and wherein the inlet to the oversize particle separator is downstream of the diverter valve.

9. An additive manufacturing powder recirculation apparatus as claimed in claim 8, wherein an outlet of the diverter valve is in fluid communication with the inlet of the oversize particle separator.

10. An additive manufacturing powder recirculation apparatus as claimed in claim 7, wherein the separator comprises a powder separator to separate powder from a gas recirculation loop, the gas separator being upstream of the diverter valve.

11. An additive manufacturing powder recirculation apparatus as claimed in claim 10, wherein an outlet of the powder separator is in fluid communication with the inlet of the diverter valve.

12. An additive manufacturing powder recirculation apparatus as claimed in claim 10, wherein the powder separator is a dynamic separator, such as a cyclonic separator.

13. An additive manufacturing powder recirculation apparatus as claimed in claim 10, wherein the diverter valve comprises a body, the body being coaxial with the outlet of the powder separator.

14. An additive manufacturing system comprising an additive manufacturing powder recirculation apparatus as claimed in claim 1 and a powder bed additive manufacturing apparatus.

15. An additive manufacturing system as claimed in claim 14, wherein the powder recirculation apparatus comprises a module which is adapted for removable attachment to the additive manufacturing apparatus.
